(19) United States
(12) Patent Application Publication
(10) Pub. No.: US 2010/0241589 A1
(43) Pub. Date: Sep. 23, 2010

(54) Visual-Aided Position Sizing and Order Entry

(76) Inventor: Daniel Honorowski, Hockessin, DE (US)

Correspondence Address: ROBERT PLOTKIN, PC, 15 New England Executive Office Park, Burlington, MA, 01803, US

(21) Appl. No.: 12/732,987

(22) Filed: Mar. 26, 2010

(51) Int. Cl. G06Q 40/00; G06F 3/048

(52) U.S. Cl. 705/36 R; 715/823; 715/764

(57) ABSTRACT

Methods and apparatuses, including computer program products, enable visual-aided position sizing and trading. A method includes displaying a graph of a financial instrument and account data representing an account balance, and receiving a risk value and an order type for the displayed financial instrument. The method displays a risk amount according to the risk value and account balance and the currency of the displayed financial instrument and an exchange rate between the financial instrument and the account balance. The method receives an entry price, a stop price and a profit target price, determines a position size and a risk/reward ratio value in response to the risk amount, entry price, stop price and profit target price, and displays the position size and risk/reward ratio value for direct order entry to a bank or broker.

### BACKGROUND

Most trading experts agree that money management is one of the most important aspects of trading. Position size, also known as trade size, bet size, or betting strategy, is one of the key elements of money management. In general, position size theory is a process of determining the amount of a particular financial instrument to trade (buy or sell). This amount is referred to as the “size” of the traded position. If one trade stocks, the position size is the number of shares traded. If one trade futures or options, the position size is the number of contracts traded. If one trades Foreign Exchange, the position size is the number of lots (Micro-$1000, Mini-$10,000,or Standard-$100,000) to trade or in some cases the actual dollar amount (Buy/Sell $132,000 or Buy/Sell $45,000) depending on the broker.

Position size based on a percent of account balance or fixed dollar amount can be used, for example, to increase returns, reduce risk, improve a risk/return ratio, or smooth an equity curve.

Position size is particularly important when leverage is involved, as with stocks, futures and foreign exchange trading. If one trades too many futures contracts, a string of losses could force one to stop trading. In fact, with the built-in leverage of these complex financial instruments, one could lose more money than one has in one's account. On the other hand, if one trades too few contracts, much of an account equity will sit idle, which will hurt the account's performance. Finding the right balance is a key element of risk management, and getting these calculations done and entered to a broker in a matter of seconds properly is even more important to winning against competing traders.

Traders often need to determine the size of a position to trade quickly and accurately, and get the order to the bank or broker. With modern day data feeds offering tick, second, range, and various charts with extremely rapid data placement onto the graphical user interface (GUI) or chart in layman terms, timing is important. In some circumstances, a delay of even seconds between the time when the need to make a trade is identified, and the time when the trade is placed, can result in a significant loss of profit, or turn a profit into a loss. Yet determining the size of a position to trade can be tedious, time-consuming, and error-prone when using existing position-sizing tools. With traditional methods it is impossible to size and enter the order to the broker in under 30 to 60 seconds, depending on the financial instrument traded, and the sizing and order entry are often presented on different interfaces or programs. What is needed, therefore, are improved techniques for determining the size of a position and placing the resulting trade quickly, easily, and accurately.

### SUMMARY

Embodiments of the present invention provide methods and apparatuses, including computer program products, for visual-aided position sizing and order entry.

For example, one embodiment of the present invention displays an intuitive Graphical User Interface (GUI) that enables position size calculations with integrated order entry. The GUI displays one or more charts of a financial instrument using an on-screen information bar. An account number, account balance, instrument currency, exchange rate, tick/pip value of instrument, and dollar risk in the traders base account currency are displayed in the information bar because of the vital role this information has in the risk equation. The system may automatically determine and display the exchange rate between the trader's account currency and the instrument currency to insure that the traders risk is always stated in the base account currency of the account they hold. Hence, a trader involved in a transaction with an instrument currency of EUR, for example, who holds an account base currency in USD, receives all risk values in USD rather than EUR. It is important to have values in one's account base currency because, for example, a risk of 1% of a USD account is much different than a risk of 1% of EUR, and vice versa. The trader need not update the information bar manually; instead, all currency rates update automatically and continuously, which eases the otherwise difficult job of the trader, who relies on updated values to produce true proper risk values.

The GUI enables the user to enter a percent risk, which represents the percentage of the trader's account balance which is at risk for each trade. In response, the system determines and displays the dollar amount at risk of the account base currency the trader is holding. The account balance is updated and correct through a live feed from the bank or broker, which eliminates the need to constantly and manually update the account balance and thus reduces the likelihood of calculation errors resulting from calculating the amount at risk based on incorrect account balances. The trader may use the GUI to select an order type for the trade to be made.

When the trader receives a signal to place a trade, the trader initiates the position size calculation order entry process, such as by clicking on an on-screen “Position Sizer” button using the GUI. In response, the system prompts the trader to select an entry price. The trader inputs the entry price by clicking on a location on the displayed chart which corresponds to the entry price. The system then prompts the trader to select a stop price. The trader inputs the stop price by clicking on a location on the displayed chart which corresponds to the stop price. The system then prompts the trader to select a trade direction or target price. If there are zero profit targets, such as when the trader intends to use a trailing stop, the trader may click anywhere on the screen in the direction of the trade. If there are one or two profit targets, then the trader may indicate these targets by clicking on the one or two target price locations on the displayed chart, which correspond to where the trader would exit and take profit.

In response to these inputs by the trader, the system determines and displays, on the chart, information such as the risk/reward ratio, the amount at risk (in the trader's account currency), and the amount of reward (in the trader's account currency). The system also automatically determines and may display the necessary position size (the amount of the instrument to purchase, such as the number of contracts/lots/dollars of the instrument to purchase) based on the information described above (such as the trader's specified percent risk and account balance). If the trader finds these values acceptable, the trader may initiate the trade, such as by clicking on a “trade position” button or providing some other input through the GUI. In response, the system places the order, of the specified order type and having the calculated position size, with the trader's broker. Upon the order being filled, the previously-indicated stop price order and target price order(s) may be placed via bracket orders so that the trader is never left unprotected.

In summary, the system enables the trader to determine the necessary position size and place an order extremely quickly, merely by clicking on a “position size” button, clicking three times on a chart, and then clicking on “trade position” button, all without performing any manual calculations or data entry. The system automatically performs any necessary currency conversions during this process.

Embodiments of the present invention support and display multiple base account currencies, auto determine FOREX Pip Values in real-time, assess contracts risk in various currencies (such as, but not limited to, $, £, ¥, C=), and aid scaling in with rapid percent risk or dollar risk adjustment.

Embodiments may include a Tick/Pip Database that alleviates the need to enter the Tick/Pip and the knowledge of their values for each individual financial instrument. With thousands of financial instruments, the margin for human error is very broad, seeing that traders switch between Charts or GUI very often as they monitor several financial markets and instruments throughout the day. This means that if a trader goes to a gold chart from a silver chart and wants to size a position, but forgets to change the Tick Values for the sizing equation, an error may result. The position size and order entry process remembers the instrument being traded, and the GUI loads and associates the proper tick/pip values with the specific financial product for the sizing equation. This saves time and reduces calculation errors.

Embodiments of the present invention may be used in connection with all world markets and provide simple point and click actions to enable, for example, a user to choose an order entry type (MKT, LMT, STP, or STPLMT) and to track a trade entry from all charts (e.g., Bar, Range, Point and Figure, Renko, Point Break).

Other features and advantages of various aspects and embodiments of the present invention will become apparent from the following description and from the claims.

### BRIEF DESCRIPTION OF THE DRAWINGS

FIG. 1 is a block diagram.

FIG. 2 is a block diagram of a graphical user interface (GUI).

FIG. 3 is a block diagram of a GUI.

FIG. 4 is a flow diagram.

Like reference numbers and designations in the various drawings indicate like elements.

### DETAILED DESCRIPTION

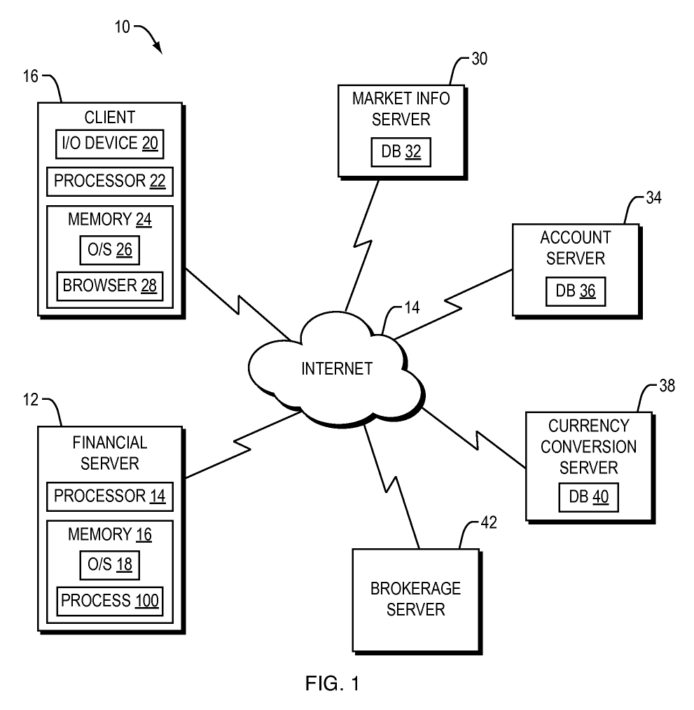

As shown in FIG. 1, an exemplary system 10 includes financial server 12 linked to a network of interconnected computers, e.g., Internet 14. The system 10 also includes a client 16 and a number of servers 30, 34, 38 and 42.

Financial server 12 includes at least a processor 14 and memory 16. Memory includes an operating system (O/S) 18, such as Windows® or Linux, and a position size and order entry process 100, described below. In the particular example shown in FIG. 1, the position size and order entry process 100 is installed and executes on the server 12. The position size and order entry process 100 may, however, be implemented in other ways. For example, the position size and order entry process 100 may alternatively be implemented as a plug-in to the browser 28 (or other software) installed on the client 16. In general, a plug-in, also referred to as a plugin, addin, add-in, addon, add-on, snap-in or snapin, is a computer program that interacts with a host application such as a web browser or an email client, to provide a certain, specific, function “on demand.” As yet another example, the position size and order entry process 100 may be implemented in multiple processes installed on multiple computers (e.g., a first process installed on the financial server 12 and a second process installed on the client 16).

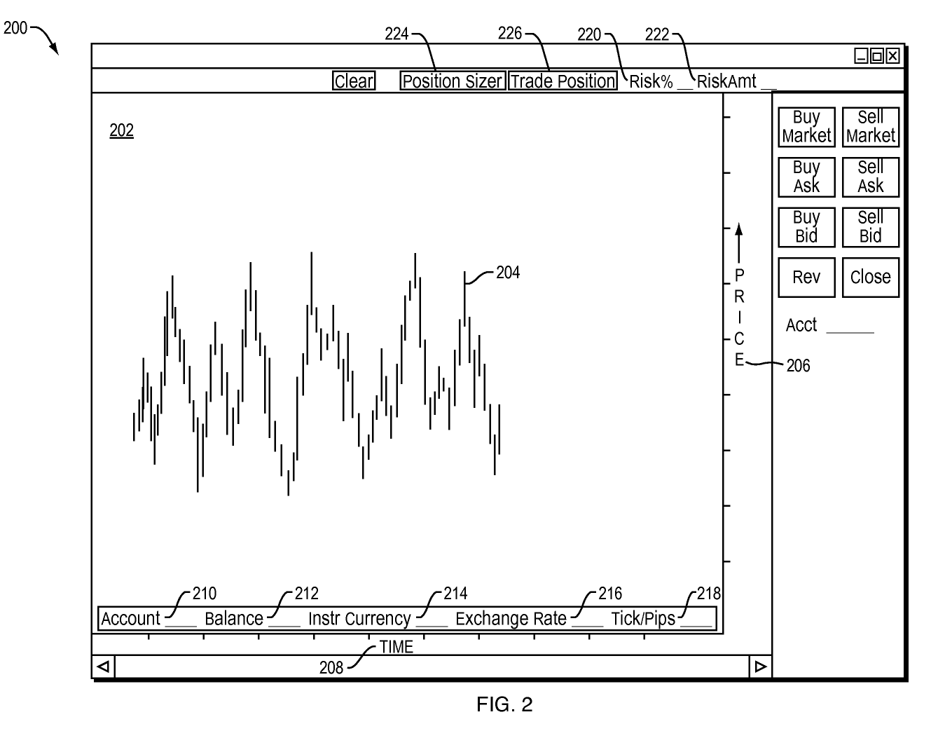

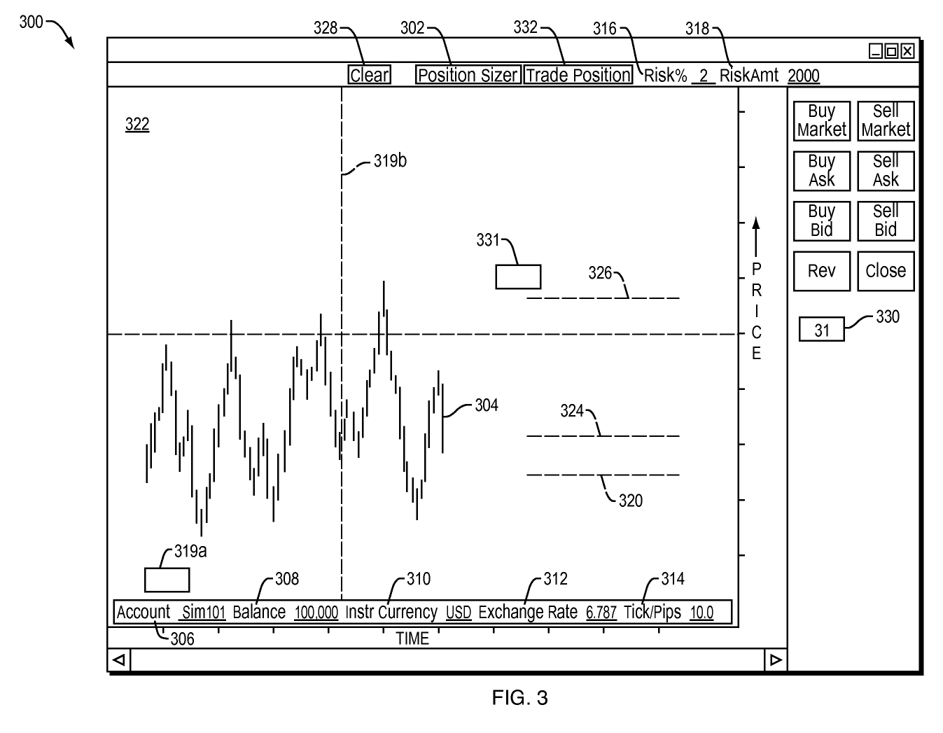

In the description below, the position size and order entry process 100 will be described as performing a variety of functions. In practice, however, some of these functions may be performed by other elements. For example, although the position size and order entry process 100 may be described below as displaying a variety of information in the charts shown in FIGS. 2 and 3, in practice such information may be displayed by other elements, possibly operating in cooperation with the position size and order entry process 100.

Client 16 includes at least an input/output (I/O) device 20, processor 22 and memory 24. Memory 24 includes an O/S 26, such as Mac OS X Snow Leopard™, Linux, or Microsoft Windows®, and a browser 28, such as Mozilla Firefox®, Opera®, or Microsoft Internet Explorer®.

In general, a browser is a software application that retrieves content and enables a user to interact with that content. In an example, a browser may retrieve content across one or more networks, such as the Internet 14. The content may include, for example, a web page, application, document, text, video, multimedia content, or any combination thereof. While the browser itself may be able to interpret some types of content, other types may require use of a specialized plug-in.

In the example system 10, server 30 is a market information server. The market information server 30 can include one or more databases 32 containing public trading market information, such as stock prices, index fund prices, mutual fund prices, futures prices, contract prices and so forth. The public trading market information can be streamed to the financial server 12 or sent in response to a request for specific market information by the position size and order entry process 100 over the network 14. The public trading market information may be free information or available through a paid subscription service.

In the example system 10, server 34 is an account server. The account server 34 can include one or more databases 36 that contain account information, such as account balances, of one or more accounts. Upon receipt of a request from the position size and order entry process 100, general and/or specific account information can be sent from the account server 34 to the position size and order entry process 100 over the network 14.

In the example system 10, server 38 is a currency conversion server. The currency conversion server 38 can include one or more databases 40 that contain current currency conversion information. The currency conversion information may be free information or available through a paid subscription service. Upon a receipt of a request from the position size and order entry process 100, current currency conversion data can be sent from the currency conversion server 38 to the position size and order entry process 100 over the network 14.

In the example system 10, server 42 is a brokerage server. The brokerage server 42 receives requests to, for example, buy or sell a stock, index fund, mutual fund, future, commodity, contract, or other financial instrument, from the position size and order entry process 100, under specific instructions from the position size and order entry process 100, such as, an order to buy or sell, a stop price, an entry price, and so forth. Upon this order being filled the stop and profit limit orders may automatically be placed due to the bracket order.

Although the servers 30, 34, 38 and 42 are shown as separate servers in system 10, in other implementations one or more of the servers 30, 34, 38 and 42 may be combined into a single server or other system, along with their respective database or databases.

As shown in FIG. 2, an example graphical user interface (GUI) 200 includes a graph region 202. Here, in one particular example, a bar chart 204 is displayed. In general, a bar chart is a graph of the price movements of a given financial instrument over a given time period, sometimes along with volume data. Charts are the main tool that technical analysts use in order to plot data and predict prices. Technical analysts may use several different types of charts in order to conduct their tests and look for patterns in the data, including line charts, bar charts, renko charts, point break charts, point and figure charts, and candlestick charts. In this particular example, bar chart 204 plots price over time 208 for an arbitrary financial instrument.

The GUI 200 includes a number of informational fields that are filled in when a particular financial instrument is displayed. These information fields can include, for example, an account field 210 for display of a particular investor's user account, a balance field 212 for display of a particular user's account balance, an instrument currency field 214 for display of the currency of the displayed financial instrument, an exchange rate field 216 for display of an exchange rate used for conversion between account currency and instrument currency and a tick/pips field 218, which is used to show the values after any conversions are done. In general, ticks and pips are all ways of describing an amount of price change. The term that is used depends upon the market being discussed, and sometimes on the amount of price change in question.

A “tick” is the smallest possible price change for the market in question, and may be anywhere on the right side of the decimal point. For example, the ES futures market might experience a price change from 1314.00 to 1314.25, which would be a price change of 1 tick.

A “pip” is the same as a tick (the smallest possible price change for the market in question), but is specifically used for the Forex markets. For example, the EURUSD (EUR to USD currency market) might experience a price change from 1.2500 to 1.2501, which would be a price change of 1 pip.

The GUI 200 includes a risk % field 220 and risk dollar amount field 222 that both may be used to enter either the number of percent to be risked or the dollar amount of the trader's base currency to be risked. This is an either/or option, meaning that if the number is entered in the risk % field 200 it will generate a dollar amount in field 222. When a dollar amount (or amount in another currency) is entered into field 222 it will give the corresponding value in field 200. When a user (who may be the owner or agent of the account for which information is displayed in the GUI 200) inputs an amount of risk they want to incur in the Risk % field 220, the position size and order entry process 100 determines a risk amount and displays the risk amount in the risk amount field 222 based on the account balance displayed in the account balance field 212. For example, if the account balance field displays $700,000 in US dollars and the risk % field displayed 1%, the position size and order entry process 100 determines and displays, as the resulting risk amount in the risk amount field 222, an amount of $7,000 (1% of $700,000). As to the previous statement, if the trader was to enter directly $7,000 in the $ Risk field 222, then the field 200 would indicate a number 1% (because $7,000 is 1% of $700,000).

GUI 200 also includes a “position sizer” button 224. The server 12 executes the position size and order entry process 100 in response to the user clicking on the position sizer button 224. The GUI 200 also includes a trade position button 226. The server 12 executes a market trade process, after the execution of the position size and order entry process 100, in response to the user clicking on the trade position button 226.

As mentioned above, the position size and order entry process 100 may be implemented as a plug-in to the web browser 28 or other application software. Examples of such applications include NinjaTrader, Esignal, MetaTrader 5, TradeStation, Sierra Charts, and Yahoo Finance. In such implementations, the position sizer plug-in may enable the application to provide features not built into the application itself. For a browser or other software application to access a plug-in, the plug-in may be required to implement a specified interface understood by the browser or other software application. Examples of plug-in interfaces include ActiveX®, used by the Internet Explorer® browser, and Netscape Plug-in Application Programming Interface (NPAPI) used by the Safari®, Opera® and Firefox® browsers. Banks and brokers provide Application Programming Interface (API) parameters which may vary among banks and brokers. The position size and order entry process 100 may, for example, be implemented using these APIs or implemented directly on the trading platform of the bank. Thus, the position size and order entry process 100 may be used with the API of the bank and brokers or be coded directly into their GUI Terminal to do a position size calculation for direct entry order without using the API provided by the banks or brokers. Examples of such platforms include, but are not limited to, Traders Workstation, GFT's (Global Forex Trading) platform named DealBook® 360 or DealBook® Web, FXCM's (Forex Capital Markets) platform named FX Trading Station, and MBTrading's platform named MBT ProDeskTop.

As shown in FIG. 3, an example GUI 300 is displayed when the position sizer button 302 is engaged by clicking on it. In this example, bar chart 304 displays the price variations of an arbitrary financial instrument over a period of time. An account field 306 represents an example account “Sim101” having an account balance field 308 indicating “100000.00 GBP” (British pounds). The financial instrument charted in bar chart 304 is shown as US Dollars in an instrument currency field 310. An exchange rate field 312 displays a current exchange rate of “0.678702,” which is used to convert the financial instrument risk of USD into the account currency of GBP. A tick/pips value field 314 displays a value of “6.67 GBP”. In this case, the contract that is in USD has a normal pip value of 10 USD but because the trader is holding an account in GBP, process 100 converts this 10 USD pip value into GBP in order to get a true risk of GBP. Therefore the 10 USD is multiplied by the USDGBP rate of 0.667245 to get a pip value in GBP of 6.67 GBP to do the risk calculations. The reason for this conversion is as follows. If a trader wants to risk 500 GBP on the transaction and is risking 10 pips on the transaction, process 100 needs to know what 10 pips equals in GBP and not USD, even though the pips are quoted in USD. At this point, process 100 converts the pips from USD to GBP, otherwise process 100 cannot do the calculation without error.

Here, a user has entered a “2%” value in the risk % field 316 and the position size and order entry process 100 determines and displays the value of the risk in GBP in a risk amount field 318; the risk amount is “2000.00 GBP,” i.e., 2% of the account balance of 100000.00 GBP.

Once the position sizer button 302 is engaged, the position size and order entry process 100 executes and displays a prompt field 319A and a navigational aid 319B, e.g., cross hairs controlled by a user to aid in navigating to various price locations shown along a y-axis in the graph region 322. The prompt field 319A prompts a user to click on an entry price with the aid of the navigational aid 319B. The position size and order entry process 100 may use the prompt field 319A to prompt the user in this way by, for example, displaying the text “Select Entry Price” within the prompt field 319A. A first mouse click 320 on the navigational aid 319B in a graph region 322 then sets an entry price, which is highlighted on a scale of the y-axis of investment instrument prices.

Once the entry price is received, the position size and order entry process 100 displays a prompt (e.g., “Select Stop Price”) in the prompt field 319A in the graph region 322, thereby prompting the user to click on a stop price using the navigational aid 319B; a second mouse click 324 in the graph region 322 sets a stop price, which is highlighted on the scale of the y-axis of investment instrument prices. Once the stop price is received, the position size and order entry process 100 displays a prompt (e.g., “Select Profit Target Price”) in prompt field 319A in the graph region 322, thereby prompting the user to enter a profit target price using the navigational aid 319B; a third mouse click 326 in the graph region 322 sets a stop price, which is highlighted on the scale of the y-axis of investment instrument prices.

The position size and order entry process 100 determines the number of financial instruments to purchase to limit the risk to 2%, i.e., 2% of the account balance of 100000.00 GBP; the number of contracts is listed in box 330. The position size and order entry process 100 also determines and displays a risk/reward value 331. If the prices entered are not satisfactory to the user, clicking on a clear button 328 clears the display of entry price, stop price and profit target price, and enables the user to begin again, with the aids of the prompt field 319A and navigational aid 319B. If the prices entered are satisfactory, clicking on a trade position button 332 engages a trading process plug-in that executes the trade.

The position size and order entry process 100 also enables selection of a particular order type for the trade, e.g., market, limit, stop, stop limit, and ATR stop (i.e., a protective stop that is based on the Average True Range indicator). In general, an ATR stop loss tool is designed to place a trailing stop from a starting point. The calculation is usually based upon the ATR indicator and the point is plotted an X number of ATR values either above or below the bar for the day. In the case of the ATR Long, a new point is plotted when a higher value is calculated. This way the stop loss value will never decline, that is, it will not chase a declining market. The reverse is also true for the ATR Short.

If an ATR stop is selected by the user, the position size and order entry process 100 automatically adjusts the user's entered stop price accordingly without user involvement and displays the results in the GUI 300.

As can be seen from the above description, the position size and order entry process 100 quickly and intuitively determines a correct position size based on the user-specified percent risk, the user's account balance, and information entered by the user by clicking only three times directly on a displayed chart. The position size and order entry process 100 automatically performs any necessary currency conversions in the process of calculating the position size. The position size and order entry process 100 also automatically places a trade on the user's behalf for a position in the specified financial instrument with a position size of the automatically-determined amount. This entire procedure does not require the user to perform any manual calculations or switch between multiple user interfaces.

In contrast, other position sizing products require a user to manually enter various values, e.g., in fields of a dialog box. More particularly, in other products, the user has to tediously key in all of the values manually and then a user's position size is calculated. If the user is satisfied with the result, the user then has to switch over to a broker and key in the values given by the position sizing product once more, introducing human error. This is a slow process and requires a lot of manual data entry, and presents many opportunities for making erroneous data entries in an order entry process. In addition, other position sizing products do not take into account exchange rates, thereby increasing the likelihood that the user will place a trade with the wrong position size. Position size and order entry process 100, in addition to getting the order properly sized and entered to the broker in a matter of seconds, reduces calculation errors tremendously due to the various auto feeds as stated previously.

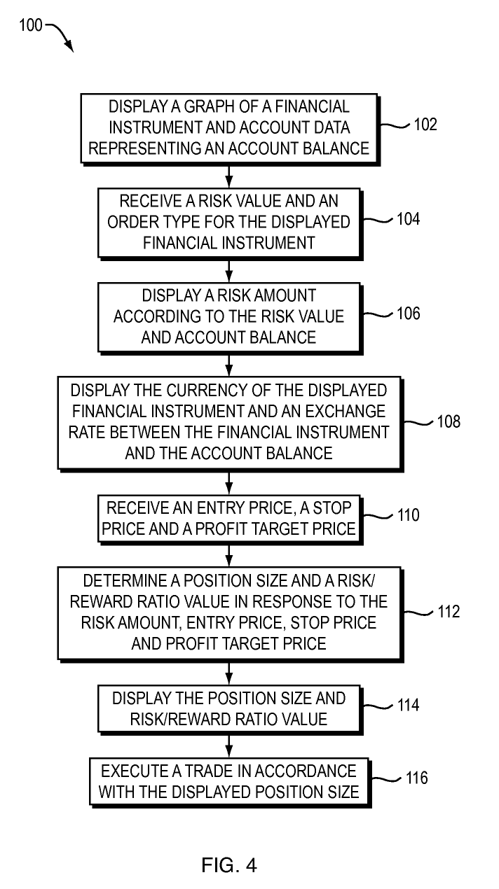

As shown in FIG. 4, the position size and order entry process 100 includes displaying (102) a graph of a financial instrument and account data representing an account balance and receiving (104) a risk value and an order type for the displayed financial instrument. The order type can be a market order (MKT), a limit order (LMT), a stop order (STP), a stop limit order (STPLMT).

Process 100 includes displaying (106) a risk amount according to the risk value and account balance.

Process 100 includes displaying (108) the currency of the displayed financial instrument and an exchange rate between the financial instrument and the account balance.

Process 100 includes receiving (110) an entry price, a stop price and a profit target price through the GUI. Receiving (110) the entry price, the stop price and the profit target price can include displaying a prompt for input and a navigational aid that enables visual navigating to various price locations corresponding to prices along the graph of the displayed financial instrument, and setting the entry price, the stop price and the profit target price in response to a click input on the navigational aid. User inputs other than clicks may, however, be used. For example, the user may move and/or select the current position of the navigational aid 319B using any form of input, such as by using a keyboard, touchpad, or voice commands provided through a microphone, in any combination. For example, the user may move the navigational aid 319B using a mouse and then select the current position of the navigational aid 319B for use in providing the entry price, stop price, or profit target price by hitting a key (such as the ENTER key or spacebar). Furthermore, the navigational aid 319B itself is optional and does not constitute a limitation of the present invention.

Process 100 includes determining (112) a position size and a risk/reward ratio value in response to the risk amount, entry price, stop price and profit target price. Determining (112) the position size can be calculated using one of several methods, including but limited to, a fixed size method, a fixed dollar amount of equity method, a fixed fractional method, a fixed ratio method, a margin target method, a leverage target method or a percent volatility method. Determining (112) the position size may include converting a currency amount from a first currency to a second currency (e.g., from the user's account currency to the currency of the financial instrument being traded, or vice versa).

Process 100 includes displaying (114) the position size and risk/reward ratio value. The position size and risk reward can be displayed in a currency of the account balance.

Process 100 includes executing (116) a trade in accordance with the displayed position size without changing screens or platforms or calculators.

The techniques described above may be implemented, for example, in hardware, software tangibly stored on a computer-readable medium, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

It is to be understood that the foregoing description is intended to illustrate and not to limit the scope of the invention, which is defined by the scope of the appended claims. Other embodiments are within the scope of the following claims.

What is claimed is:

1. A method comprising:
in a graphical user interface (GUI) rendered on a computer input/output (I/O) device, displaying a graph of a financial instrument;
receiving a risk value through the GUI;
receiving an entry price, a stop price and a profit target price through the GUI;
determining a position size and a risk/reward ratio value in response to the risk amount, entry price, stop price and profit target price; and
displaying the position size and risk/reward ratio value in the GUI.

2. The method of claim 1 further comprising displaying account data representing an account balance.

3. The method of claim 1 further comprising receiving an order type for the displayed financial instrument.

4. The method of claim 3 further comprising executing a trade in accordance with the order type and displayed position size.

5. The method of claim 3 wherein the order type is selected from the group consisting of market order (MKT), limit order (LMT), stop order, stop order (STP) and stop limit order (STPLMT).

6. The method of claim 1 wherein receiving the entry price, the stop price and the profit target price comprises:
displaying a prompt for input and a navigational aid that enables visual navigating to various price locations corresponding to prices along the graph of the displayed financial instrument;
setting the entry price, the stop price and the profit target price in response to a click input on the navigational aid; and
highlighting the entry price, the stop price and the profit target on respective price locations along the graph of the displayed financial instrument.

7. The method of claim 2 further comprising displaying a risk amount determined from the risk value and account balance.

8. The method of claim 2 further comprising displaying the currency of the displayed financial instrument and an exchange rate between the financial instrument and the account balance.

9. The method of claim 1 wherein determining the position size is calculated from the group consisting of a fixed size method, fixed dollar amount of equity method, fixed fractional method, fixed ratio method, margin target method, leverage target method and percent volatility method.

10. The method of claim 1 wherein the position size and risk reward are displayed in a currency of the account balance.

11. A system comprising:
a server linked to a client in a client server network, the client including at least a processor and memory, memory including a browser process for displaying information including a graph of a financial instrument and a position sizing plug-in that when activated, causes execution of a position size and order entry process residing in a memory of the server, the position size and order entry process comprising:
receiving a risk value;
receiving an entry price, a stop price and a profit target price through the GUI;
determining a position size and a risk/reward ratio value in response to the risk amount, entry price, stop price and profit target price; and
displaying the position size and risk/reward ratio value for direct order entry to a bank or broker.

12. The system of claim 11 wherein the position size and order entry process further comprises displaying account data representing an account balance.

13. The system of claim 11 wherein the position size and order entry process further comprises receiving an order type for the displayed financial instrument.

14. The system of claim 13 wherein the position size and order entry process further comprises executing a trade in accordance with the order type and displayed position size.

15. The system of claim 13 wherein the order type is selected from the group consisting of market order (MKT), limit order (LMT), stop order (STP), and stop limit order (STPLMT).

16. The system of claim 11 wherein receiving the entry price, the stop price and the profit target price comprises:
displaying a prompt for input and a navigational aid that enables visual navigating to various price locations corresponding to prices along the graph of the displayed financial instrument;
setting the entry price, the stop price and the profit target price in response to a click input on the navigational aid; and
highlighting the entry price, the stop price and the profit target on respective price locations along the graph of the displayed financial instrument.

17. The system of claim 12 wherein the position size and order entry process further comprises displaying a risk amount determined from the risk value and account balance.

18. The system of claim 12 wherein the position size and order entry process further comprises displaying the currency of the displayed financial instrument and an exchange rate between the financial instrument and the account balance.

19. The system of claim 11 wherein determining the position size is calculated from the group consisting of a fixed size method, fixed dollar amount of equity method, fixed fractional method, fixed ratio method, margin target method, leverage target method and percent volatility method.

20. The system of claim 11 wherein the position size and risk reward are displayed in a currency of the account balance.

21. A storage medium including computer readable instructions, which, executed by a processor, cause the processor to carry out a method of position size and order entry comprising:
in a graphical user interface (GUI) rendered on a computer input/output (I/O) device, displaying a graph of a financial instrument;
receiving a risk value through the GUI;
receiving an entry price, a stop price and a profit target price through the GUI;
determining a position size and a risk/reward ratio value in response to the risk amount, entry price, stop price and profit target price; and
displaying the position size and risk/reward ratio value in the GUI for direct order entry to a bank or broker.

22. The storage medium of claim 21 wherein the position size and order entry method further comprise displaying account data representing an account balance.

23. The storage medium of claim 21 wherein the position size and order entry method further comprises receiving an order type for the displayed financial instrument.

24. The storage medium of claim 23 wherein the position size and order entry method further comprises executing a trade in accordance with the order type and displayed position size.

25. The storage medium of claim 23 wherein the order type is selected from the group consisting of market order (MKT), limit order (LMT), stop order (STP), and stop limit order STPLMT).

26. The storage medium of claim 21 wherein receiving the entry price, the stop price and the profit target price comprises:
displaying a prompt for input and a navigational aid that enables visual navigating to various price locations corresponding to prices along the graph of the displayed financial instrument;
setting the entry price, the stop price and the profit target price in response to a click input on the navigational aid; and
highlighting the entry price, the stop price and the profit target on respective price locations along the graph of the displayed financial instrument.

27. The storage medium of claim 22 wherein the position size and order entry method further comprises displaying a risk amount determined from the risk value and account balance.

28. The storage medium of claim 22 wherein the position size and order entry method further comprises displaying the currency of the displayed financial instrument and an exchange rate between the financial instrument and the account balance.

29. The storage medium of claim 21 wherein determining the position size is calculated from the group consisting of a fixed size method, fixed dollar amount of equity method, fixed fractional method, fixed ratio method, margin target method, leverage target method and percent volatility method.

30. The storage medium of claim 21 wherein the position size and risk reward are displayed in a currency of the account balance.
